(19) United States
(12) Patent Application Publication
(10) Pub. No.: US 2008/0200164 A1
(43) Pub. Date: Aug. 21, 2008

(54) Method and Apparatus for Speech Quality Assessment in a Cellular Communication System

(75) Inventors: Timothy Charity, Devizes (GB); Rashmi Misra, Gloucestershi (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/908,576

(22) PCT Filed: May 26, 2006
(86) PCT No.: PCT/US06/20836

§ 371 Date: Apr. 29, 2008

(30) Foreign Application Priority Data
Jun. 30, 2005 (GB) 0513592.6

(51) Int. Cl. H04Q 7/30

(52) U.S. Cl. 455/424

(57) ABSTRACT

The invention relates to an apparatus and method for speech quality assessment in a cellular communication system. The apparatus (113) comprises a second receiver (117) which receives encoded speech data for a speech segment from a remote speech source over an air interface voice channel (111) of the cellular communication system. The apparatus (113) further comprises a first receiver (115) which receives a reference speech sample corresponding to the speech segment from a remote reference speech sample source. The first and second receivers (115, 117) are coupled to a speech processor (119) which determines a speech quality characteristic by comparison of the reference speech sample and the encoded speech data. The encoded voice data may be transmitted over an air interface voice channel (111) whereas the reference sample may be transmitted over a first air interface channel (105) which specifically may be a data channel having a very low bit error rate. The invention may allow an effective, flexible and distributed speech assessment.

### FIELD OF THE INVENTION

The invention relates to a method and apparatus for speech quality assessment in a cellular communication system and in particular but not exclusively, to speech assessment in a remote terminal or a base station of the cellular communication system.

### BACKGROUND OF THE INVENTION

Over the past decades, cellular communication systems have become ubiquitous and today make up a major part of the communication service provision in many regions.

In a cellular communication system, a geographical region is divided into a number of cells each of which is served by a base station. The base stations are interconnected by a fixed network which can communicate data between the base stations. A mobile station is served via a radio communication link by the base station of the cell within which the mobile station is situated. Communication from a mobile station to a base station is known as uplink, and communication from a base station to a mobile station is known as downlink.

Currently, the most ubiquitous cellular communication system is the 2nd generation communication system known as the Global System for Mobile communication (GSM). Further description of the GSM TDMA communication system can be found in ‘The GSM System for Mobile Communications’ by Michel Mouly and Marie Bernadette Pautet, Bay Foreign Language Books, 1992, ISBN 2950719007.

In the past years, 3rd generation systems have been deployed to further enhance the communication services provided to mobile users. An example of such a communication system is the Universal Mobile Telecommunication System (UMTS), which is currently being deployed. Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

Although, 2^{nd} generation systems are continuously enhanced to provide further communication services and 3^{rd} generation systems have been designed to provide a variety of different communication services, the most important and most widely used communication service is still that of voice communication.

Consequently, one of the most important parameters of a cellular communication system is thus the voice quality perceived by the users. Accordingly, methods and techniques for measuring and accessing such voice quality are of significant interest for operators and manufacturers of cellular communication systems.

Typically, such assessment requires the use of dedicated test equipment which is designed and arranged specifically to measure voice quality. This is expensive and complicated and specifically requires that the test equipment is distributed to locations where the voice quality is to be measured. Furthermore, specific test operations are typically used which may result in measurement results that are not representative of the voice quality perceived by typical users of an active cellular communication system.

Specifically, measuring the downlink and uplink voice quality usually requires the provision of test equipment in the field to compare received speech samples with a reference sample. For example, most existing methods require audio to be recorded by a dedicated mobile station and then manually transferred back to a system from where the recorded audio was sent to the mobile station. The system may then compare the received recorded audio to the speech which was originally transmitted. However, such an approach is suboptimal and is in particular complicated, inflexible, impractical, requires dedicated test equipment and results in a complex and inconvenient test procedure.

An improved speech quality assessment would be advantageous and in particular a system for determining a speech quality in a cellular communication system allowing increased flexibility, facilitated measurement operation, reduced requirements for dedicated test equipment and/or improved accuracy of the speech quality assessment would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention, there is provided an apparatus for speech quality assessment in a cellular communication system, the apparatus comprising: first receiving means for receiving encoded speech data for a speech segment from a remote speech source over an air interface voice channel of the cellular communication system; second receiving means for receiving a reference speech sample corresponding to the speech segment from a remote reference speech sample source; and assessment means for determining a speech quality characteristic by comparison of the reference speech sample and the encoded speech data.

The invention may allow improved and/or facilitated speech quality assessment. The invention may for example allow speech assessment to be performed without requiring dedicated test equipment to be distributed as the test may be made using active remote terminals. For example, a simple firmware or software routine in a standard remote terminal may provide the required functionality.

An accurate and flexible speech assessment for the speech segment when communicated over the air interface voice channel may be obtained. The assessment may be performed in different locations and is not limited to a source originating or forwarding the speech signal.

The speech quality characteristic may for example be a speech quality measure determined by a comparison between the received encoded speech data and the reference speech sample using any suitable algorithm or criteria for determining a speech quality by a comparison to a reference signal. For example, the speech quality characteristic may be a characteristic indicative of a perceived speech quality, such as a Mean Opinion Score (MOS).

According to an optional feature of the invention, the reference speech sample is received over an air interface data channel of the air interface.

The reference speech sample and the encoded speech data may be received over different channels of the air interface. For example, both the encoded speech data and the reference speech sample may be transmitted over the air interface but the reference speech sample may be transmitted over a data channel having desired attributes such as a very low bit error rate. Thus, a reliable reference speech sample may be provided to the assessment means despite this being transmitted over the air interface.

According to an optional feature of the invention, the reference speech sample is a losslessly waveform encoded sample of a digitized speech signal.

This may provide a particularly accurate representation of the original speech segment and may be highly suitable for a reference signal for a speech quality assessment.

According to an optional feature of the invention, the apparatus further comprises means for statistically processing a plurality of determined speech quality characteristics.

This may provide an improved characterisation of the performance of the cellular communication system. Hence, the invention may allow accurate statistical evaluation while allowing a facilitated, flexible and/or improved distributed determination of speech qualities.

According to an optional feature of the invention, the first receiving means are located in a remote terminal and the second receiving means and the assessment means are located in a fixed network of the cellular communication system, and the remote terminal further comprises means for communicating the received encoded speech data to the assessment means over an uplink air interface channel.

This may provide a flexible and highly advantageous implementation in some application scenarios. For example, a distributed determination of the downlink speech quality for individual remote terminals may be achieved while allowing a centralisation of some test functionality.

According to an optional feature of the invention, the apparatus further comprises means for receiving an assessment activation signal and the apparatus is arranged to determine the speech quality characteristic for the speech segment in response to the assessment signal.

This may allow an improved test operation and may allow a centralised control of when to perform speech quality assessment. The feature may for example facilitate synchronisation or the association between the reference speech sample and the encoded speech data.

According to an optional feature of the invention, the assessment signal may comprise an indication of the speech segment.

This may facilitate operation in many embodiments and may in particular facilitate or enable synchronisation or association between the reference speech sample and the encoded speech data.

According to an optional feature of the invention, the apparatus further comprises means for storing the encoded speech data in response to the activation signal.

This may facilitate operation in many embodiments and may in particular facilitate or enable synchronisation or association between the reference speech sample and the encoded speech data.

According to an optional feature of the invention, the remote speech source is the same as the remote reference speech sample source.

The remote speech source and the remote reference speech sample source may for example be a single network element of the fixed network of the cellular communication system, such as a network element interfacing to fixed line voice communication system.

According to an optional feature of the invention, the apparatus is a remote terminal of the cellular communication system and the air interface voice channel is a downlink channel.

The invention may allow improved and/or facilitated downlink speech quality assessment. The invention may for example allow speech assessment to be performed by remote terminals of the cellular communication system. The speech quality may be individually determined in remote terminals based on signals received at the individual remote terminals. Furthermore, a simple firmware or software routine may provide the required functionality.

A remote terminal may e.g. be a communication unit, a 3rd Generation User Equipment (UE), a subscriber unit, a mobile station, a communication terminal, a personal digital assistant, a laptop computer, an embedded communication processor or any physical, functional or logical communication element which is capable of communicating over the air interface of the cellular communication system.

According to an optional feature of the invention, the apparatus further comprises means for receiving a speech quality assessment application over the air interface and the assessment means is arranged to determine the speech quality characteristic by executing the application.

This may facilitate operation and may allow e.g. standard remote terminals to perform speech assessment without any prior configuration or functionality for this purpose.

According to an optional feature of the invention, the apparatus further comprises means for communicating the speech quality characteristic to a fixed network based statistical speech quality analysis processor.

This may provide an improved characterisation of the performance of the cellular communication system. Hence, the invention may allow accurate statistical evaluation while allowing a facilitated, flexible and/or improved distributed determination of speech qualities using the functionality and resources of individual remote terminals.

According to an optional feature of the invention, the remote source is a remote terminal of the cellular communication system and the air interface voice channel is an uplink air interface channel.

The invention may allow improved and/or facilitated uplink speech quality assessment. The invention may for example allow speech assessment to be performed by base stations of the cellular communication system. The speech quality may be individually determined in e.g. base stations based on signals received from individual remote terminals. Furthermore, a simple firmware or software routine may provide the required functionality.

The encoded speech data and the reference speech sample may for example be transmitted to a base station from a remote terminal and the speech assessment may be performed by a base station or other network element of the fixed network of the cellular communication system.

According to an optional feature of the invention, the apparatus further comprises means for transmitting an uplink speech quality indication to the remote terminal.

This may allow a user of the remote terminal to be informed of the quality or may allow an application to take the current speech quality into account.

According to an optional feature of the invention, the assessment means is comprised in a base station of the cellular communication system.

This may provide a particular advantageous performance and/or implementation in many scenarios.

According to a second aspect of the invention, there is provided method of speech quality assessment in a cellular communication system, the method comprising: receiving encoded speech data for a speech segment from a remote speech source over an air interface voice channel of the cellular communication system; receiving a reference speech sample corresponding to the speech segment from a remote reference speech sample source; and determining a speech quality characteristic by comparison of the reference speech sample and the encoded speech data.

According to a third aspect of the invention, there is provided a computer program product for executing the above mentioned method.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system comprising an apparatus for speech quality assessment in accordance with some embodiments of the invention; and

FIG. 2 illustrates an example of a cellular communication system comprising an apparatus for downlink speech quality assessment in accordance with some embodiments of the invention.

### DETAILED DESCRIPTION OF SOME EMBODIMENTS OF THE INVENTION

The following description focuses on embodiments of the invention applicable to a GSM cellular communication system. However, it will be appreciated that the invention is not limited to this application but may be applied to many other cellular communication systems including for example 3^{rd} Generation cellular communication systems such as UMTS.

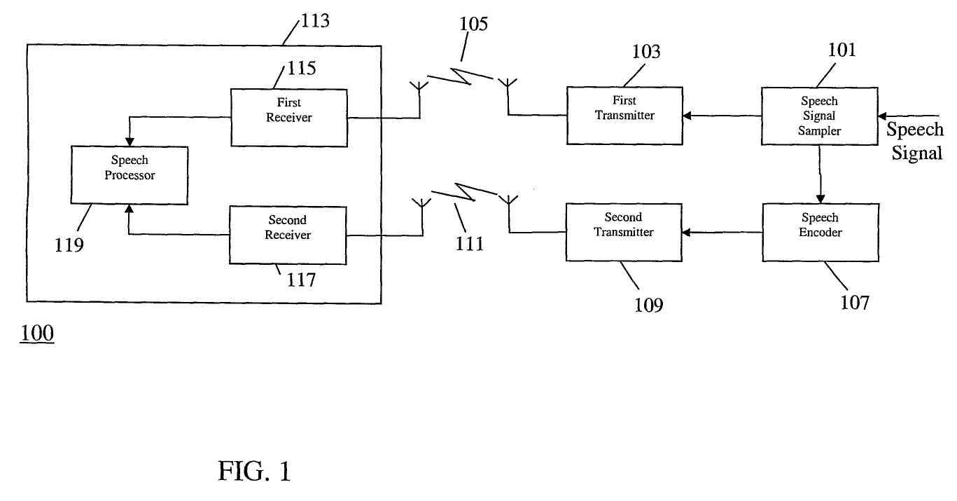

FIG. 1 illustrates an example of a cellular communication system 100 comprising an apparatus for speech quality assessment in accordance with some embodiments of the invention.

In the example of FIG. 1, the cellular communication system comprises a speech signal sampler 101 that receives a speech signal which is digitised as a waveform PCM (Pulse Code Modulated) signal. Thus, the speech signal sampler 101 generates a waveform encoded speech signal. The signal can for example be received from an external communication network by a core network of the cellular communication system 100.

The speech signal sampler 101 is coupled to a first transmitter 103 which is capable of transmitting the PCM signal over a first air interface channel 105. A given speech segment of the PCM signal can specifically be transmitted without any further speech coding and the transmitted signal may thus be a losslessly encoded reference sample for a specific speech segment. In the example, the first air interface channel 105 may be a standard data channel as specified by the GSM Technical Specifications and may specifically be a GPRS (General Packet Radio Service) air interface channel. It will be appreciated that in other embodiments, other channels can be used and specifically the reference sample can in some embodiments be transmitted using a fixed network communication channel (i.e. may not necessarily be transmitted over the air interface).

The speech signal sampler 101 is further coupled to a speech encoder 107 which performs speech encoding in accordance with the Technical Specifications for the specific cellular communication system. For example, for a GSM cellular communication system, the speech encoder 107 may be a half rate or full rate GSM speech encoder.

The encoded speech data from the speech encoder 107 is fed to a second transmitter 109 which is arranged to transmit the encoded speech data over an air interface voice channel 111. The air interface voice channel 111 is specifically a standard voice channel as specified by the GSM Technical Specifications.

An apparatus 113 comprises a first receiver 115 which is arranged to receive data over the first air interface channel 105 and a second receiver 117 which is arranged to receive data over the air interface voice channel 111. Thus, the first receiver 115 receives the reference speech sample for the speech segment and the second receiver 117 receives the encoded speech data for the same speech segment.

Specifically, the air interface voice channel 111 can be a standard voice channel used for supporting voice services in the communication system, and may in particular be a voice channel currently used for supporting a communication for which the speech quality is to be assessed. The first air interface channel 105 can be a data channel for which data is communicated with high reliability. For example, the air interface bit error rate (following forward error correcting coding and decoding) may be very low and/or a retransmission scheme may be used to provide very high reliability.

Thus, the apparatus 113 receives both the encoded speech data of the air interface voice channel 111 as well as a reference speech sample which very accurately reflects the original PCM encoded speech signal from the speech signal sampler 101. The encoded speech data is processed and transmitted as a standard voice signal and accordingly reflects the speech quality provided to the user for the specific conditions associated with the second receiver 117. Indeed, the reference speech sample can be substantially identical to the PCM signal for the speech segment and the encoded speech data can be speech data supporting a standard and currently active speech service.

The first receiver 115 and the second receiver 117 are coupled to a speech processor 119 which is arranged to determine a speech quality characteristic by comparison of the reference speech sample and the encoded speech data.

Specifically, the speech processor 119 may compare the received encoded speech data for the speech segment with the reference speech sample. As the reference speech sample can be independent of the specific conditions and characteristics impacting the communication of the speech signal (for example, the reference speech sample can be transmitted using a virtually error free data service), the comparison can accurately reflect the speech quality for the current conditions and characteristics.

In particular, in a cellular communication system, the speech quality heavily depends on the current radio conditions for the specific air interface voice channel and by separating the communication of the reference speech sample and the encoded speech data, the impact on the speech signal of radio conditions can be isolated and assessed.

Furthermore, a large degree of flexibility and convenience can be achieved by the communication of the reference speech sample to the location of the speech processor 119. For example, the speech assessment can be performed at any suitable location and by any suitable element and functional unit without requiring centralised processing by the entity generating the speech sample. For example, the apparatus 113 can be implemented in a remote terminal or in a base station.

Also, a flexible and low complexity speech quality assessment process can be performed. The speech quality determination can be performed by low complexity software or firmware routines which can easily be included in standard communication equipment. Thus, the requirement for dedicated and specialised test equipment can be reduced.

Moreover, speech quality assessment can conveniently be performed in a distributed way and the system may allow a large number of speech communications to be assessed. Thus, a large amount of speech quality assessment data can conveniently be produced accurately reflecting the actual operational characteristics and conditions of the cellular communication system thereby allowing a network operator to optimise the system. Thus, an improved performance of the cellular communication system as a whole can be achieved resulting in e.g. an improved user quality of service.

It will be appreciated that although FIG. 1 illustrates separate transmitter circuitry, receiver circuitry and antennas for the air interface voice channel 111 and first air interface channel 105, many practical embodiments will utilise the same hardware for providing the required functionality.

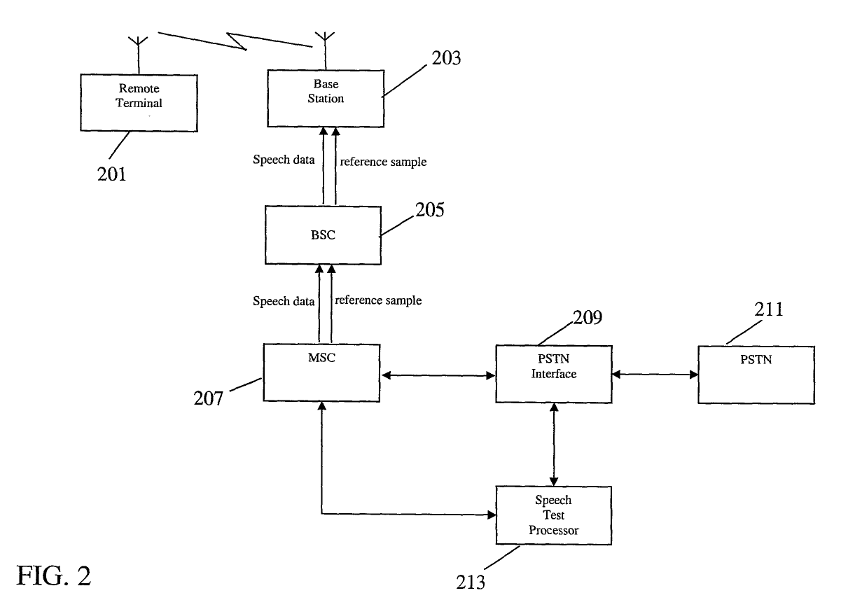

FIG. 2 illustrates an example of a cellular communication system comprising an apparatus for downlink speech quality assessment in accordance with some embodiments of the invention.

In the example, the speech quality for a downlink air interface voice channel to a remote terminal 201 is determined at the remote terminal 201 itself.

In the system of FIG. 2, the first remote terminal 201 communicates with a base station over the air interface in accordance with the GSM Technical Specifications which will be well known to the person skilled in the art.

The base station 203 is coupled to a Base Station Controller (BSC) 205 which is further coupled to a Master Switch Centre (MSC) 207 as will be well understood by the skilled person and which for brevity and clarity will not be described in detail.

The MSC 207 is coupled to a PSTN interface 209 which interfaces to an external Public Switched Telephone Network (PSTN) 211. The MSC 207 and the PSTN interface 209 are furthermore coupled to a speech test processor 213.

As a specific example, the remote terminal 201 can be active in a voice communication with a remote party supported by the PSTN 211. Specifically, the remote terminal 201 may be involved in a fixed to mobile voice call.

In the downlink direction, the PSTN 211 can provide speech data in accordance with the Signalling System 7 (SS7) protocol to the PSTN interface 209. This signal can be encoded by a GSM encoder in the PSTN interface 209 and forwarded to the MSC 207 as GSM voice encoded data. The MSC 207 routes the data to the base station 203 through standard voice channels of the interfaces of the fixed network, and the base station 203 transmits the GSM encoded data over an air interface voice channel. The remote terminal 201 receives the data and converts it into sound as is well known in the art.

In the example of FIG. 2, the speech quality of the received speech can be flexibly, accurately and conveniently assessed by the remote terminal 201 itself.

Specifically, the speech test processor 213 can extract the speech data received from the PSTN 211 for a given speech segment. For example, data for a one second interval can be extracted. A reference sample for the speech segment can then be generated by the speech test processor 213. The extracted data can be encoded with a high quality (such as a lossless waveform encoding) or the extracted data from the PSTN may e.g. be used directly.

The speech test processor 213 can then proceed to feed the reference sample to the MSC 207 for communication to the remote terminal 201. However, the reference sample is transmitted through different channels than the encoded voice data. Specifically, the reference sample is transmitted as a data signal with a very low error rate. In some embodiments, the reference sample can be transmitted using a packet data service such as a GPRS packet data service. This can ensure that the reference sample is received with high quality and in particular a data packet retransmission scheme may be used on the air interface to ensure that the bit error rate is reduced to substantially zero.

Thus, the remote terminal 201, in addition to receiving the encoded speech data supporting the voice call, also receives a reference sample for a speech segment of this encoded data.

In this example, the remote terminal 201 furthermore comprises functionality for assessing the speech quality for the speech segment by comparing the reference sample to the received encoded speech data for the segment. Specifically, in this example, the apparatus 113 of FIG. 1 can be comprised in the remote terminal 201.

As a specific example, the speech processor 119 can determine a speech quality in response to the reference sample and the encoded data by use of a standard objective voice quality assessment algorithm, such as for example a PESQ—Perceptual Evaluation of Speech Quality, PSQM—Perceptual Speech Quality Measure (ITU Rec. P.861)or PAMS—Perceptual Analysis/Measurement System algorithm.

Thus, the remote terminal 201 in the example autonomously determines a speech quality for the voice communication supported by the air interface voice channel. The determined speech quality can accurately reflect the perceived speech quality by the user of the remote terminal 201 and can be determined using a low complexity algorithm implemented at the remote terminal itself. In particular, a standard remote terminal can determine the speech quality using a simple algorithm and the requirement for dedicated test remote units may be obviated.

With reference to FIG.1, the apparatus 113 can be considered to be implemented in the remote unit 201 with the first and second receiver 115, 117 being implemented by the GPRS receiving functionality and the voice channel receiving functionality of the remote terminal 201 respectively.

In the example of FIG. 2, the remote terminal 201 can further communicate the determined speech quality back to the fixed network. In particular, a large number of remote terminals can individually determine speech qualities and can communicate these to a central processor which is arranged to perform a statistical processing of the determined speech qualities.

For example, the determined speech qualities for a group of remote terminals can all be communicated back to the speech test processor 213 using standard data communication services, such as a GPRS packet data service. The speech test processor 213 can then process this information to determine if the network operates in accordance with a desired quality profile and/or to identify areas or services for which an adequate speech quality is not achieved. The network operator can use this information to evaluate and optimise the performance of the cellular communication system.

In the described example, the downlink speech quality is determined in the remote terminal 201. However, in other embodiments, the speech quality can be determined in the fixed network. For example, the encoded speech data can be received at the remote terminal 201 and can be stored for the specific speech segment. The stored data speech data can then be transmitted back to the base station 203, e.g. over a reliable GPRS packet data communication channel. The base station 203 can receive the encoded speech data and can also receive the reference speech sample from the speech test processor 213 and can then proceed to determine the speech quality.

Thus, in such an embodiment, the second receiver 117 of FIG. 1 may correspond to the remote terminal whereas the first receiver 115 may correspond to a network interface receiving the reference sample from the BSC 205. Furthermore, the speech processor 119 may be implemented in the base station 201 and the coupling between the second receiver 117 and the speech processor 119 may be via an air interface data channel. Thus, the apparatus 113 of FIG. 1 may be considered to be distributed between the remote terminal 201 and the base station 203.

In the examples described above, the speech quality of an ongoing voice communication is assessed. In some embodiments, the speech test processor 213 may itself generate a speech sample which is encoded and transmitted to the remote unit 201 in accordance with the Technical Specifications of the cellular communication system. Thus, the speech test processor 213 may generate both the encoded speech data and the reference sample and the air interface voice channel may only be set up for communication of the specific test speech segment.

It will be appreciated that although the above description has focused on determining speech quality for a downlink communication, the principles apply equally well to determination of uplink speech quality.

Specifically, the air interface voice channel can be an uplink air interface channel and the remote terminal 201 can be the source of the reference sample as well as the encoded data.

For example, for the communication with the remote party coupled to the PSTN 211, the remote terminal 201 can encode data in accordance with the GSM Technical Specifications and transmit this to the remote party. The speech test processor 213 can intercept and store this data. In addition, the remote terminal 201 can generate a reference sample, for example by lossless waveform encoding, and transmit this directly to the speech test processor 213. The speech test processor 213 can then proceed to determine the speech quality for the uplink by comparing the stored data to the reference sample.

In some embodiments, the speech test processor 213 can further send an indication of the determined uplink speech quality to the remote terminal 201 thereby providing the user or an application of the remote terminal 201 with information of the speech quality experienced by the remote party.

In some embodiments, the speech test processor 213 may further control when the speech quality assessment is being performed and may in particular specify a speech segment for which the speech quality should be determined.

Specifically, the speech test processor 213 can generate an activation signal and transmit this to the remote terminal 201 which can perform the test in response to this. For example, the speech test processor 213 can send a message identifying a specific time interval for which the remote terminal 201 should store the received encoded data. The speech test processor 213 can then generate the reference sample for this specific time interval thereby ensuring a synchronised test operation.

In some embodiments, the remote terminal 201 may perform the speech assessment using an application which is downloaded over the air interface. In particular, in addition to the speech test processor 213 transmitting an activation signal, it can also transmit a speech assessment application which can be executed by the remote terminal 201. Thus, the speech test processor 213 can effectively centrally control the speech quality determination at the remote terminals while allowing this determination to be performed in a distributed way and with low complexity. In particular, standard remote terminals capable of executing downloaded applications can be used.

As a specific example of how a downlink speech quality may be,determined, the following steps can be executed:
1. Speech for a call is sampled in the fixed network. This can e.g. be done either at the MSC, or by connecting a probe on the signalling link. A sample of speech s of known duration is recorded digitally to mass storage, e.g. hard disk. The destination address or phone number of the target remote terminal is also recorded. The destination remote terminal PDP (Packet Data Protocol) context is queried at the Home Location Register (HLR) to find the target Internet Protocol (IP) address for the target remote terminal.
2. The application which has sampled the speech now sends an activation message to the target remote terminal instructing it to prepare to record a received speech sample for analysis. This message can be sent to a target application in the remote terminal, for example using OMA-DM (Open Mobile Alliance Device Management) or SyncML as the protocol.
3. The speech frames are sent to the target remote terminal over the air interface for voice traffic in the normal way.
4. The digitally recorded sample s is sent to the target remote terminal over a suitable packet radio service such as GPRS. In this way a substantially ‘perfect’ copy of s can be transmitted to the target remote terminal.
5. The target remote terminal receives the copy of s, and can then perform a comparison with the sample received over the air interface. An objective voice quality assessment figure of merit can now be calculated, using one of the standard algorithms such as the Perceptual Evaluation of Speech Quality (PESQ) algorithm.
6. Optionally the remote terminal can store the calculated figure of merit, and/or send it back to the originating application on the fixed network, again using OMA-DM or similar protocol.
7. By repeating steps 1-6, distributions of downlink measured voice quality can be generated, at either the remote terminal or at the MSC or controlling application, or both.
8. As an alternative to transmitting the copy of s to the remote terminal, the sample of speech recorded at the remote terminal can be transmitted back to the controlling application, for example over OMA-DM, for comparison to be made, instead of performing the comparison at the remote terminal.

As a specific example of how a downlink speech quality can be determined, the following steps can be executed:
1. An application resident on the MSC, or on a host with access to the SS7 connection, instructs a remote terminal to store a sample of speech s beginning at time t for duration d. This message can be sent using OMA-DM or similar protocol.
2. The remote terminal receives the message, and at time t it begins sampling the speech which it is transmitting on the uplink to the base station (in the case that a voice call is in progress).
3. The remote terminal records the sample s and transmits it to the controlling application over a packet radio link (e.g. GPRS).
4. The remote terminal sends the speech on the radio uplink in the normal way.
5. The controlling application traces the speech frames on the SS7 link and extracts the relevant speech frames and records them to mass storage.
6. The recorded speech frames are then compared to the sample s which has been transmitted over the packet radio interface, and an objective figure of merit for the received uplink voice quality can be made.
7. Optionally the calculated voice quality figure of merit can be sent back to the remote terminal to inform it of the uplink quality.
8. By repeating steps 1-6 or 1-7, distributions of objective uplink voice quality metrics can be obtained either at the remote terminal or in the fixed-link based application.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for speech quality assessment in a cellular communication system, the apparatus comprising:
first receiving means for receiving encoded speech data for a speech segment from a remote speech source over an air interface voice channel of the cellular communication system;
second receiving means for receiving a reference speech sample corresponding to the speech segment from a remote reference speech sample source; and
assessment means for determining a speech quality characteristic by comparison of the reference speech sample and the encoded speech data.

2. The apparatus claimed in claim 1 wherein the reference speech sample is a losslessly waveform encoded sample of a digitized speech signal.

3. The apparatus claimed in claim 1 further comprising means for statistically processing a plurality of determined speech quality characteristics.

4. The apparatus claimed in claim 1 wherein the first receiving means are located in a remote terminal and the second receiving means and the assessment means are located in a fixed network of the cellular communication system, and the remote terminal further comprises means for communicating the received encoded speech data to the assessment means over an uplink air interface channel.

5. The apparatus claimed in claim 1 further comprising means for receiving an assessment activation signal and wherein the apparatus is arranged to determine the speech quality characteristic for the speech segment in response to the assessment signal.

6. The apparatus claimed in claim 1 wherein the assessment signal comprises an indication of the speech segment.

7. The apparatus claimed in claim 1 further comprising means for storing the encoded speech data in response to the activation signal.

8. The apparatus claimed in claim 3 further comprising means for communicating the speech quality characteristic to a fixed network based statistical speech quality analysis processor.

9. A method of speech quality assessment in a cellular communication system, the method comprising:
receiving encoded speech data for a speech segment from a remote speech source over an air interface voice channel of the cellular communication system;
receiving a reference speech sample corresponding to the speech segment from a remote reference speech sample source; and
determining a speech quality characteristic by comparison of the reference speech sample and the encoded speech data.
